(19) United States
(12) Patent Application Publication
(10) Pub. No.: US 2010/0247835 A1
(43) Pub. Date: Sep. 30, 2010

(54) ELASTIC STRIP WITH SELF ADHESION

(75) Inventors: Hsing-Tsung LIN, Shengang Township (TW); Chih-Ming Ou, Shengang Township (TW)

Correspondence Address: EGBERT LAW OFFICES, 412 MAIN STREET, 7TH FLOOR, HOUSTON, TX, 77002, US

(73) Assignee: SUN-GOOD GLUE COMPANY LTD., Shengang Township (TW)

(21) Appl. No.: 12/813,887

(22) Filed: Jun. 11, 2010

Related U.S. Application Data
(63) Continuation-in-part of application No. 11/454,565, filed on Jun. 19, 2006.

(51) Int. Cl. B32B 33/00

(52) U.S. Cl. 428/41.8

(57) ABSTRACT

An elastic strip with self-adhesion effect of double viscosity has self-adhesive first, second elastic layers and at least a release paper. The first and second elastic layers are molded by mixing thermo plastic rubber, resin and bonding agent to realize self-adhesion and scalability of the entire plate structure. The first and second adhesion surfaces formed at one side of the first and second elastic layers not yet mated are provided with different adhesive strength. For two bonding surfaces formed at first and second elastic layers, the adhesive strength is larger than that of the first and second adhesion surfaces. The release paper is adhered onto either the first or second adhesion surface, and can be easily peeled off. Due to self-adhesion without debonding and residual gelatine, the elastic strip can be widely applied to multi-functional adhesive products resisting overturn, sliding, shock and theft, thus improving the living quality and convenience.

### CROSS-REFERENCE TO RELATED U.S. APPLICATIONS

This application is a Continuation-In-Part (CIP) Application of U.S. patent application Ser. No. 11/454,565 filed on Jun. 19, 2006, the disclosure of which is incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to an adhesive tape, and more particularly to an innovative one which comprises thermo plastic rubber, resin and bonding agent, featuring environmental protection, self-adhesion, resistance to debonding/residual settlement and non-reaction.

2. Description of Related Art Including Information Disclosed Under 37 CFR 1.97 and 37 CFR 1.98.

There are currently available with a variety of adhesive tapes. For example: common tape, double-sided tape, pull tape and inert tape. However, most conventional tapes cannot be adhered repetitively, that means, its viscosity will be lost once it is used, so a huge restriction is placed on such tapes. In spite of the fact that an inert tape is widely applied to the note paper and can be used repetitively, the inert tape will have to be discarded once the note paper is used.

At present, all existing adhesive tapes are of a “reactive” structure, namely, both structure and viscosity are acquired from chemical reactions. After the product is fabricated, the side-layer materials cannot be recycled, leading to considerable waste and serious environmental pollution.

Thus, to overcome the aforementioned problems of the prior art, it would be an advancement if the art to provide an improved structure that can significantly improve the efficacy.

Therefore, the inventor has provided the present invention of practicability after deliberate experimentation and evaluation based on years of experience in the production and development of related products.

### BRIEF SUMMARY OF THE INVENTION

The present invention provides a “non-reactive” hot melt elastic strip structure, which is molded by mixing thermo plastic rubber, resin and bonding agent to form an integrated self-adhesive plate without need of chemical reaction. Such a unique structure allows for the recycling of the remaining waste, melted into a liquid state and fabricated into new product (adhesion effect unchanged). Thus, the waste can be recycled to reduce the resource waste for environmental protection.

The elastic strip of the present invention is composed of thermo plastic rubber, resin and a bonding agent, so the entire structure presents self-adhesion and non-debonding without residual gelatine. Hence, this structure can be utilized repetitively prior to degradation of its physical property. Even if the adhesion is reduced due to dust adhesion, the viscosity can be resumed only by cleaning up the surface, so the elastic strip of the present invention can be widely applied to multi-functional adhesive products resisting overturn, sliding, shock and theft.

Based on the structural configuration of the present invention wherein said elastic strip is composed of two plates with different adhesive strength, users can apply the plate of stronger viscosity to permanent adhesion, and that of poorer viscosity to repetitive adhesion. Moreover, the adhesive strength of the third degree of viscosity is larger than that of the first and second degrees of viscosity. The differential adhesive strength is configured to ensure a stronger adhesive strength between the first and second elastic layers. When the first or second adhesion surface is peeled off from said release paper or external adhesion object, the first and second elastic layers cannot be separated due to stronger adhesive strength.

Based on the structural configuration of the present invention wherein a flexible plate with a decorative portion is adhered between the first and second elastic layers, the elastic strip is available with functions of decoration, graphical representation and ads marking, etc, making it possible to meet the diversified user demands.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows an exploded perspective view of the preferred embodiment of the present invention.

FIG. 2 shows a sectional view of the preferred embodiment of the present invention.

FIG. 3 shows a perspective view of another assembled preferred embodiment of the present invention.

FIG. 4 shows an exploded perspective view of another preferred embodiment of the present invention.

FIG. 5 shows a partially assembled sectional view of another preferred embodiment of the present invention.

### DETAILED DESCRIPTION OF THE INVENTION

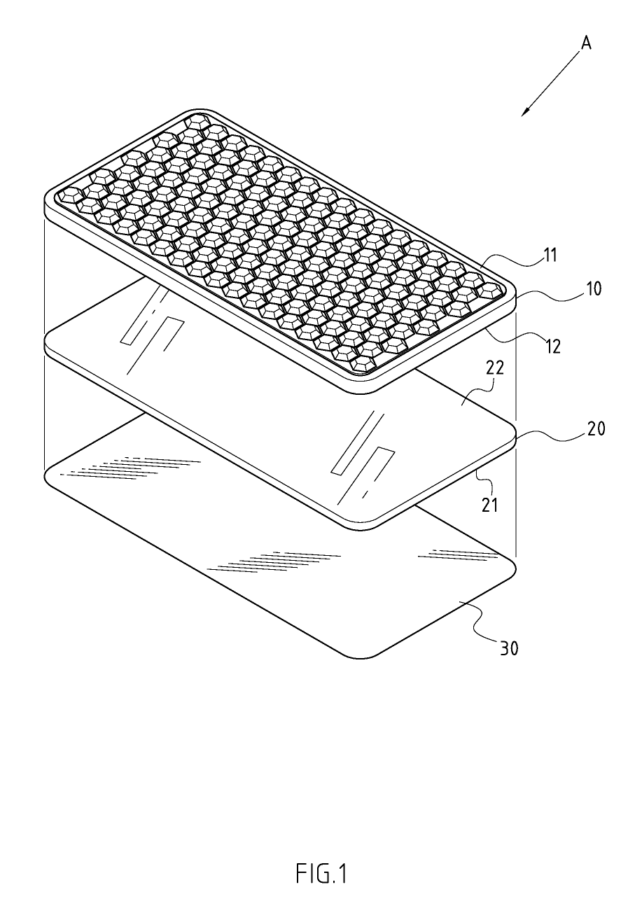

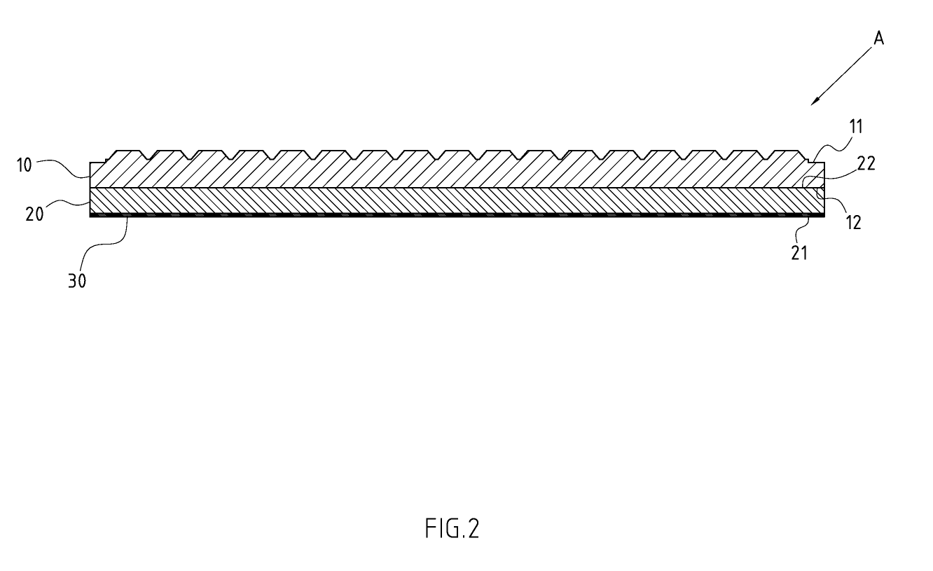

FIGS. 1 and 2 depict preferred embodiments of an elastic strip of the present invention with self-adhesion effect, which, however, are provided for only explanatory objective for patent claims. Said elastic strip A including a self-adhesive first elastic layer 10, molded by mixing thermo plastic rubber, resin and bonding agent to realize self-adhesion and scalability. Said first elastic layer 10 also includes two sides.

A self-adhesive second elastic layer 20 is overlapped with one side of said first elastic layer 10 into a fixation state. The second elastic layer 20 is also molded by mixing thermo plastic rubber, resin and bonding agent to realize self-adhesion and scalability. Said second elastic layer 20 also includes two sides.

A first adhesion surface 11 with first degree of viscosity is formed by one side of the first elastic layer 10 not mated with the second elastic layer 20. The first adhesion surface 11 is provided with preset first degree of viscosity.

A second adhesion surface 21 with second degree of viscosity is formed by one side of the second elastic layer 20 not mated with the first elastic layer 10. The second adhesion surface 21 is provided with preset second degree of viscosity.

Two bonding surfaces 12 and 22 with third degree of viscosity are formed at two overlapped sides of the first elastic layer 10 and the second elastic layer 20. These two bonding surfaces 12, 22 are provided with preset third degree of viscosity.

At least one release paper 30 is adhered onto either the first adhesion surface 11 or the second adhesion surface 21. Said release paper 30 can be easily peeled off.

The first and second degrees of viscosity refers to different adhesive strength. The adhesive strength is configured in a manner to apply the adhesion surface of stronger viscosity to permanent adhesion, and that of poorer viscosity to repetitive adhesion.

The adhesive strength of the third degree of viscosity is larger than that of the first and second degrees of viscosity. The differential adhesive strength is configured to ensure a stronger adhesive strength between the first elastic layer 10 and the second elastic layer 20. When the first adhesion surface 11 or the second adhesion surface 21 is peeled off from said release paper 30 or an external adhesion object, the first elastic layer 10 and the second elastic layer 20 cannot be separated due to stronger adhesive strength.

Said first elastic layer 10 and second elastic layer 20 are heat-resisting, poisonless, odorless and recyclable without debonding and residual gelatine.

Of which, the different adhesive strength of the first adhesion surface 11 and second adhesion surface 21 is caused by the first elastic layer 10 and the second elastic layer 20 of different adhesive strength.

Alternatively, the different adhesive strength of the first adhesion surface 11 and second adhesion surface 21 is caused by the different surface roughness of the first adhesion surface 11 and second adhesion surface 21 (e.g. lines and spacing lugs).

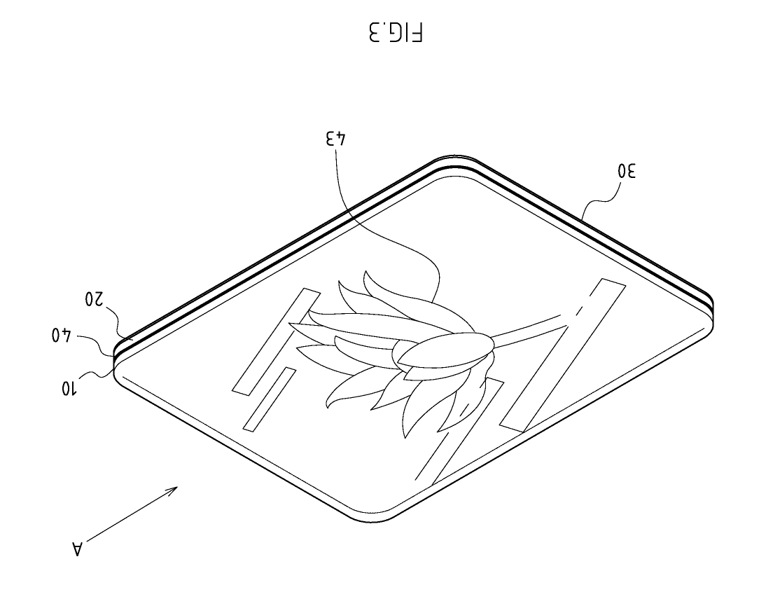

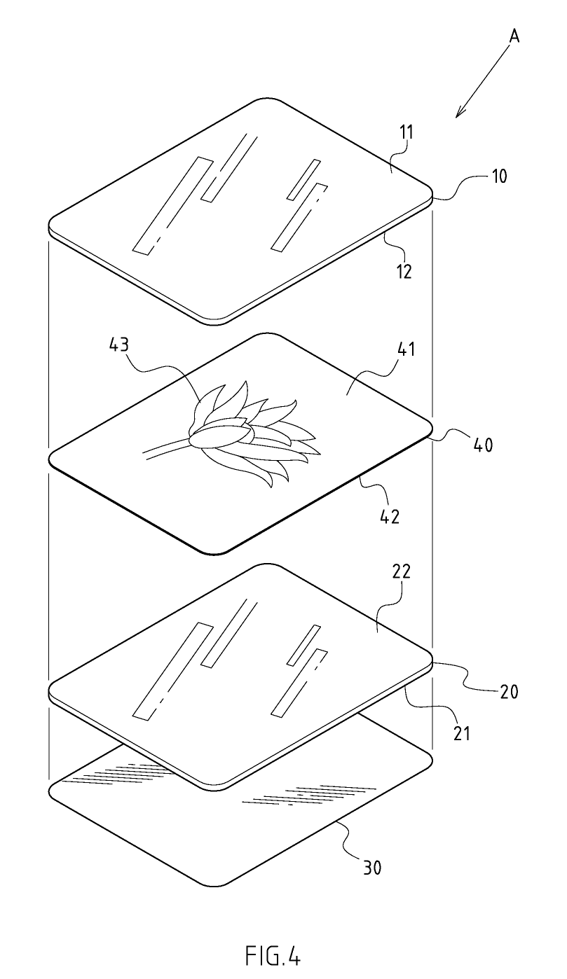

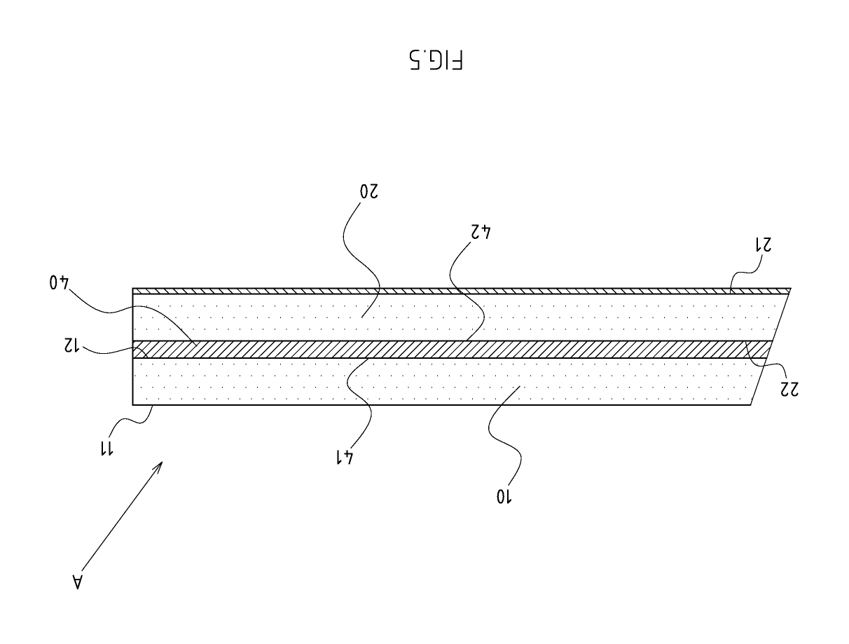

Referring to FIGS. 3, 4 and 5, a flexible plate 40 can be adhered between the first elastic layer 10 and the second elastic layer 20. The flexible plate is of 38 μm˜200 μm in thickness, and defined into a first surface 41 and a second surface 42, either of which is provided with a decorative portion 43. Of which the decorative portion 43 is of patterns, letters, flower marks and color blocks or their combinations. With the configuration of the preferred embodiment, the elastic strip is available with auxiliary functions of decoration, graphical representation and ads marking, etc.

1. An elastic strip with self-adhesion effect of double viscosity comprising:
a self-adhesive first elastic layer, molded by mixing thermo plastic rubber, resin and bonding agent to realize self-adhesion and scalability, said first elastic layer having two sides;
a self-adhesive second elastic layer, which is overlapped with one side of said first elastic layer into a fixation state; the second elastic layer is also molded by mixing thermo plastic rubber, resin and bonding agent to realize self-adhesion and scalability; said second elastic layer having two sides;
a first adhesion surface with a first degree of viscosity formed by one side of the first elastic layer not mated with the second elastic layer; the first adhesion surface is provided with a preset first degree of viscosity;
a second adhesion surface with a second degree of viscosity formed by one side of the second elastic layer not mated with the first elastic layer; the second adhesion surface is provided with a preset second degree of viscosity;
two bonding surfaces with a third degree of viscosity formed at two overlapped sides of the first and second elastic layer; said two bonding surfaces are provided with a preset third degree of viscosity;
at least a release paper adhered onto either the first or second adhesion surface; said release paper can be easily peeled off;
of which, the first and second degrees of viscosity refers to different adhesive strength;
of which, the adhesive strength of the third degree of viscosity is larger than that of the first and second degrees of viscosity.

2. The structure defined in claim 1, wherein said first and second elastic layers are heat-resisting, poisonless, odorless and recyclable without debonding and residual gelatine.

3. The structure defined in claim 1, wherein the different adhesive strength of the first and second adhesion surfaces is caused by the first and second elastic layers of different adhesive strength.

4. The structure defined in claim 1, wherein the different adhesive strength of the first and second adhesion surfaces is caused by the different surface roughness of the first and second adhesion surfaces.

5. The structure defined in claim 1, wherein a flexible plate is adhered between the first and second elastic layers; the flexible plate is of 38 μm˜200 μin thickness, and defined into a first and a second surface, either of which is provided with a decorative portion.

6. The structure defined in claim 5, wherein said decorative portion is of patterns, letters, flower marks and color blocks or their combinations.
